(19) United States
(12) Patent Application Publication
(10) Pub. No.: US 2013/0151291 A1
(43) Pub. Date: Jun. 13, 2013

(54) System and method for building on-demand aviation trip

(71) Applicant: Sumant Salway, Katy, TX (US)

(72) Inventor: Sumant Salway, Katy, TX (US)

(21) Appl. No.: 13/567,199

(22) Filed: Aug. 6, 2012

Related U.S. Application Data
(60) Provisional application No. 61/568,288, filed on Dec. 8, 2011.

(51) Int. Cl. G06Q 10/02

(52) U.S. Cl. 705/5

(57) ABSTRACT

A method and a system for building an on-demand aviation trip are provided. The system automatically identifies a set of service requirements and clearance requirements for a given trip, and handles tasks involved in arranging service providers for the set of service requirements to allow scheduler to self-build the trip. The system further obtains necessary information to automatically populate necessary forms to obtain the required clearances for the trip. Service requests and confirmation for the service requests are archived with reference to the service requirement of the trip and the parties relevant to the requests and confirmation are provided with real-time notification for receipt of such communications. The system also employees an online auction scheme to promote competition among the service providers to provide the schedulers with higher quality of service at lower price.

### RELATED APPLICATION DATA

This application claims the priority of prior U.S. provisional application Ser. No. 61/568,288 filed on Dec. 8, 2011, which is hereby incorporated by reference herein in its entirety.

### TECHNICAL FIELD

Embodiments of the present invention relate generally to automation of managing information, and more particularly to a method and a system for simplifying the workflow of a personalized on-demand flight trip.

### BACKGROUND

As with any other forms of transportation, aviation can be divided into two basic categories: a scheduled and a non-scheduled flight. The scheduled aviation can be best understood as general commercial airlines, which can be characterized as safe, relatively low price, and frequent connections between major cities throughout the world, albeit lacking the flexibility to serve many less populated cities. On the other hand, the non-scheduled aviation can be described as on-demand air transportation service, which provides air transportation from one point to another in a manner and at a time designated by the person exercising the control.

On-demand aviation can be categorized as personal or business, but the regulations and underlying operations of the two are essentially the same; only the purpose of the trip separates the two. Business aviation, or sometimes referred to as corporate aviation, is generally defined as “an aircraft owned or leased and operated by a corporation or business firm for the transportation of personnel or cargo in furtherance of the corporation's or firm's business and which are flown by professional pilots receiving a direct salary or compensation for piloting.”

In an average year, hundreds of millions of people travel for business purposes worldwide. Even with modern communication technologies and ever increasing network speeds, the needs for the face-to-face meeting never seems to decrease in the business world. Instead, the increased productivity brought by the advanced technologies opened more business opportunities, which necessitated even more business trips. The on-demand, business aviation was particularly beneficial for the businesses as it provided the ability to transport its employees in a timely fashion without being limited by inefficient connections and schedules of commercial airline services. The efficient and reliable scheduling provided by the business aviation, in turn, increased the productivity of company's most valuable assets—people and time. For some companies, keeping their key employees business trip routes in private could literally mean securing business information. On-demand aviation is not a luxury asset for companies, but it's rather a part of corporate culture, which seems to be a fixture in the business world for the foreseeable time.

Most companies that engage in business aviation have their own in-house flight department, which operates its own aircraft. The aircraft is owned or leased by the company, and housed in a leased or wholly owned hanger of a conveniently located airport. The aircraft are flown by full-time professional pilots to support the corporate traveller's needs.

As the name implies, in-house flight department allows for direct control over the scheduling, response time, aircraft utilization, flight operation, maintenance as well as expense. For this reason, the in-house flight department provides the highest level of customization, control, and potentially, the highest quality transportation service for its travellers.

In general, having more control over the company's aviation assets translates into more administration and management tasks. A basic workflow of a typical flight department operation is as follows:

A trip request is received by the department

Feasibility for the trip is determined

Availability of a flight crew and suitable aircraft is determined

The trip is confirmed and scheduled

Detailed trip information is gathered and disseminated

The trip is flown

Flight information is recorded and stored

The overall operations are tracked and accomplished by a flight department manager who may also be the scheduler, the chief pilot or the chief maintenance manager within the department. Numerous underlying tasks by many different personnel are involved in carrying out the basic routine operation safely, effectively, and efficiently. Typically, the pilots, technicians, and flight department manager are deeply involved in a wide range of detailed operational tasks. However, these tasks are often fragmented and highly compartmentalized, taking these individuals away from the hanger for significant periods or time, thereby denying them the big picture of the total operation. Although each flight department may operate differently, the scheduler is often the person who communicates with other flight department personnel as well as various service providers, thereby functioning as a central point of information and reference.

While all operational factors are ultimately responsible by the pilot in command (“PIC”), the scheduler can make his or her task easier and provide independent source of critical information. Not only is the scheduler the central communication and information point for other personnel in the department, the scheduler is also the one who receives the request for transportation from the passengers. Depending on the size of the company and the size of its flight department, the scheduler may be an administrative assistant of the traveller assigned with the duty of scheduling the aircraft. Regardless of the title, the scheduler must work closely with the chief pilot to ensure the passengers' trip request is served under the availability of the aircraft, limitations on flight crews as well as maintenance schedules.

The scheduling function is arguably the most critical function of the department. After all, the department operates for the purpose of providing the on-demand air transportation. Receiving a transportation request and recording the details of trip from the passengers, however, is only a fraction of the scheduler's duty.

The scheduler is often required to arrange all kinds of service requirements for the trip, including the personal service requirements like in-flight catering services, ground transportations and accommodations for flight crews and passengers, as well as various aircraft service requirements like ground handling and fuel services through any of the service providers such as handlers, fixed-based-operators (“FBO”), agents, caterers, limo companies and the likes. Checking the availability of flight crews and aircraft, obtaining operational information from pilots and aviation maintenance technicians (“AMT”) are also coordinated by the scheduler. In addition, scheduler may be asked to keep track of flight records, passenger/flight crew manifests, obtain or generate flight plans. On top of these, there are many other general administrative duties, such as contracting with third party service providers to ensure proper services, regularly advising the passengers (or future passengers) on the status and requirements of the trip as well as general information management duty of keeping the financial and/or operational record. In a case where the scheduler is also the pilot, the scheduler/pilot may even need to know and furnish complex duties, such as setting weight and balance, planning flight route, managing flight crew duty time, and dealing with air traffic control (“ATC”) and airport for required clearances.

As a trip is built by the scheduler, a number of details must be captured and tracked through a number of inevitable changes occurring prior to flight. For instance, the AMT may have forgotten about a regulatory pre-flight aircraft maintenance, which prevents the aircraft from taking off. A scheduled flight crew may not show up on time, causing delay in the entire trip schedule. Sudden weather change is yet another classic example that affects the flight and trip plans. The scheduler must rebuild the trip according to these unexpected changes made to scheduled trip. With all of the aforementioned tasks and efforts put in by the scheduler, rearranging the entire trip plan per unexpected changes is certainly a daunting and yet frequently required additional duty of the scheduler.

Unexpected changes can also occur during the trip by the passenger requiring modification to the trip schedule or passenger services in between the legs of a trip. Such sudden changes made to scheduled trip put the scheduler's responsiveness and communication skill to test. Because the scheduler acts as a central information hub for the trip, others, including the passengers, flight crews and service providers rely solely on the scheduler to foresee all aspects of the trip affected by any unexpected changes and take appropriate measures. Any missed communication to the relevant party of trip will cost time and money to the passenger, thereby defeating the original purpose of the on-demand aviation.

Attempts have been made to simplify the workflow of the scheduler by providing flight scheduling software for in-house flight departments. This type of software allows one to manually create a trip itinerary by filling out a tabular trip sheet, and helps to keep track of the flight department's operational activities. Some software allows for preloading the company's passenger, flight crew and aircraft information, which greatly speeds the flight scheduling process and keeping records of the flights in a consistent searchable format.

Such flight scheduling software, however, still rely on a scheduler to manually carry out a variety of actions to “build” a trip. As the initial matter, all of the tasks required for actually carrying out the trip as scheduled must be known or identified by the scheduler. For instance, the scheduler must identify services required by the aircraft selected for the trip, services required by the passengers as well as a list of clearances and permits necessary for the trip. Of course, a set of required tasks for each trip vary depending on a variety of factors, including origin/destination locations, flight plan, weather forecast, availability of landing slots at an airport and availability of service providers.

Not only must she identify the set of items necessary for the trip, but the scheduler must also manually take appropriate actions to arrange required services and to obtain required clearances. To arrange services, the scheduler is often required to manually retrieve contact information of service providers for service requirements for the trip, contact each of the service providers to verify availability and to obtain quotes, and compare the prices and terms offered by the service providers. When a particular service provider is selected, an appropriate service request must be made to the service provider either by sending a completed service request form or by submitting the service request via the service provider's website. Likewise, requests for clearances must be manually filled out and provided to appropriate authorities. Typically, confirmations and invoices from each individual service provider are provided via email or fax that are not integrated to the flight scheduling software used by the scheduler, and manually keeping track of communications relating to the trip is an administrative burden created by the conventional flight scheduling software.

In addition, the scheduler must still keep track of statuses for each and every tasks required for the trip. If some tasks (e.g., maintenance checking, fueling, getting overflying permit) are not completed on-time and causes any changes to the scheduled trip, the scheduler may need to repeat the aforementioned service arrangement process as most changes trigger either new requests or cancellations that need to be sent to the respective service provider and authority.

Realizing the problems faced by the schedulers, a service provider known as fixed based operators (“FBO”) started offering multiple aircraft service requirements including fueling, hangaring, tie-down and parking, aircraft maintenance, as well as lavatory cleaning services, all at once. Some of the larger FBOs are capable of handling the passenger service requirements, including in-flight catering, ground transportation, hotel reservations and various other concierge services for both flight crews and passengers, thereby fulfilling the entire service requirements of a trip at certain airport. While all-in-one service offered by FBOs somewhat simplified the workflow of a scheduler, it also effectively limited the ability to individually select or customize a desired service requirement. In a sense, such practices by FBOs increased the overall price by including unnecessary or potentially lower quality services. In other words, the simplified workflow is obtained at the expenses of ability to fully customize the trip plan and increased cost. Even with increased number of FBOs, the industry still lacks a system to promote competition among the FBOs to balance the aforementioned shortcomings.

Even when the flight departments are dissatisfied with certain service providers, no system exists that allows the flight departments to obtain useful and unbiased (e.g., non-advertisement, non-sponsored review) information as to alternative service providers. Many flight departments are at even more disadvantage when it needs to obtains services at foreign destinations that are not visited regularly. Lacking information and viable alternatives, flight departments often pay significant fees to a middleman in return for securing service requirements from various unknown service providers.

Accordingly, it would be highly desirable to have a method and a system that can automatically identifies necessary requirements of a given trip and takes appropriate actions to satisfy the identified requirements and other routine tasks. It would also be desirable to have a system that provides an efficient means for providing real-time updates regarding changes made on the scheduled trip to all relevant parties. Moreover, it would be desirable to have a system that promotes competition among the service providers and provides flight departments with information useful for choosing alternative service providers. Such system would provide flight departments with a means for securing higher quality services at reduced expenses, while simplifying the entire workflow.

### BRIEF SUMMARY

Embodiments of the present invention relate to building an on-demand aviation trip. In an embodiment, a scheduler provides one or more trip parameters to a trip building application via a communication network. The trip parameters indicate at least one set of a departure location, a destination location and a schedule for the trip. Using the trip parameter, the trip building application generates a trip requirement data, which identifies a set of service requirements for the trip. For each of the identified service requirements, a service provider data containing a set of service providers that can fulfill the service requirement is generated. The service provider data is presented to the scheduler to select a service provider for each of the identified service requirements to build the trip, wherein each of the selected service providers is automatically provided with a respective service request and a request for a confirmation.

The scheduler and the service providers are provided with real-time notification for receipt of communications between the scheduler and the service providers, including the service request, additional information request from the service provider as well as confirmation for the service request. These communications are archived with reference to the trip. Further, the scheduler or the service providers are periodically provided with a reminder alert if a requested service requirement is not confirmed within a predetermined amount of time.

In an embodiment, all service providers in the set of service providers identified for a particular service requirement are provided with a bid submission request. Bids received from the service providers are shared among said set of service providers to promote competition. The received from the service providers are included in the service provider to be presented to the scheduler.

In another embodiment, one or more clearances required by one or more aviation authorities are determined based on the trip parameter, including flight route, flight plan, and passenger information. Upon identifying the required clearances, appropriates request forms the required clearances are retrieved from various informational sources. The clearance request forms are automatically populated by the trip building application by retrieving necessary information from the various information sources, and the populated forms are made available to the corresponding aviation authorities along with a request for confirmation.

In yet another embodiment, the trip building application recalibrates the trip requirement data upon identifying any substantial changes made to the existing trip. This generates new service requirement data containing a set of service providers that require either new or an update on the existing service requests, and each service provider in the set is provided with a respective service request and a request for a confirmation.

In yet another embodiment, the trip building application obtains feedback data, such as user review and service rating, from the passengers, the scheduler, and the flight crews of the trip regarding various aspects of the service providers and stored in the shared knowledge database, thereby allowing the feedback data to be used by another scheduler as reference in selecting a service provider for a service requirement of a trip.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left most digit in the corresponding reference number.

FIG. 1 is a block diagram of an exemplary system for building an on-demand business aviation trip, according to an embodiment of the present invention.

FIG. 2A is a screenshot of an exemplary user interface, according to an embodiment of the present invention.

FIG. 2B is a screenshot of an exemplary user interface, according to an embodiment of the present invention.

FIG. 2C is a screenshot of an exemplary user interface, according to an embodiment of the present invention.

FIG. 2D is a screenshot of an exemplary user interface, according to an embodiment of the present invention.

FIG. 2E is a screenshot of an exemplary user interface, according to an embodiment of the present invention.

FIG. 2F is a screenshot of an exemplary user interface, according to an embodiment of the present invention.

FIG. 2G is a screenshot of an exemplary user interface, according to an embodiment of the present invention.

FIG. 2H is a screenshot of an exemplary user interface, according to an embodiment of the present invention.

FIG. 2I is a screenshot of an exemplary user interface, according to an embodiment of the present invention.

FIG. 2J is a screenshot of an exemplary user interface, according to an embodiment of the present invention.

FIG. 3 is a flowchart of an exemplary method for building an on-demand business aviation trip, according to an embodiment of the present invention.

FIG. 4A is a screenshot of an exemplary user interface, according to an embodiment of the present invention.

FIG. 4B is a screenshot of an exemplary user interface, according to an embodiment of the present invention.

FIG. 4C is a screenshot of an exemplary user interface, according to an embodiment of the present invention.

FIG. 5 is a block diagram illustrating an exemplary computer system that may be implemented as computer-readable code, according to an embodiment of the present invention.

### DETAILED DESCRIPTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Although the present invention is intended to provide a tool for a flight department personnel or a passenger to self-build an on-demand aviation trip, the term “user” in the present disclosure may include flight crews, service providers and even various aviation authorities. In addition, even though many examples of embodiments are explained in reference to actions of a “scheduler,” it should be understood that the term “scheduler” is used to refer broadly and inclusively to any individual performing actions to schedule a trip. Accordingly, a passenger himself or even a member of flight crew can be treated as a scheduler as would be apparent to a person skilled in the art given this description.

### Overview

A method and a system for building on-demand business aviation trip are described herein. The on-demand business aviation trip building system (referred herein after as the “trip building system”) of present disclosure can be used by passengers, any employees working in flight departments, flight crews, service providers and aviation authorities (e.g., ATC, Civil Aviation Authority). Each of the aforementioned individuals and entities can interact with the system via a user terminal. However, each may be provided with different user interface and functionality, depending on their role in the trip building process and their access privilege level. Using the user terminal, a scheduler or even a passenger can build the entire trip by providing just a few basic trip scheduling elements like destination(s) and schedule(s).

From the basic trip scheduling elements, the trip building system automatically gathers additional information, determines a set of service requirements and a set of clearance requirements for the trip, and automates tasks necessary for arranging the identified service requirements and obtaining the clearances. For each service requirement, the system generates a list of service providers available to fulfill the service, and presented to the scheduler or the passenger to select a service provider. In some embodiments, the system is configured to obtain and present the scheduler with supplemental information regarding the available service providers, such as service rating information and user reviews. The system may also integrate an online bidding scheme with respect to the service requirements, thereby promoting competition among the service providers. In some embodiments, the system can be configured to presents the submitted bid prices to the user to select a service provider, or alternatively, the system can be configured to automatically select a service provider based on a set of predetermined criterions.

The system further automates the entire trip building process by automatically submitting necessary service request and clearance request to the selected service providers and corresponding aviation authorities, respectively. For all tasks that are not automated by the system (e.g., tasks involving user inputs, actual tasks to be performed by the service providers, etc.), the system monitors the progress and provides alerts to the scheduler and/or to the other corresponding party, so that all necessary tasks are carried out within the required time limit. With convenient access to the user terminal, progress status can be updated by the party handling manual tasks, and monitored by other parties with real-time notification. Not only does it allow relevant parties to monitor the progress of the tasks, but the system also takes appropriate actions when it determines some modification to the trip is necessary.

As described above, the on-demand aviation trip building system greatly simplifies the workflow of building an on-demand aviation trip by automating most of cumbersome tasks that were previously done in manual. The system also serves as a central communication hub enabled to provide real-time notification concerning receipt of request, receipt of confirmation for the request, status updates to the tasks, and any changes to the trip, to all relevant parties. All communications between the scheduler and other parties are recorded in a conveniently accessible format. Accordingly, the system provides a self-serving tool for a scheduler or even a passenger to build a fully customized on-demand aviation trip without having to rely on expensive middlemen or pay for unwanted services offered by a bundle service provider.

### Exemplary On-Demand Aviation Trip Building System

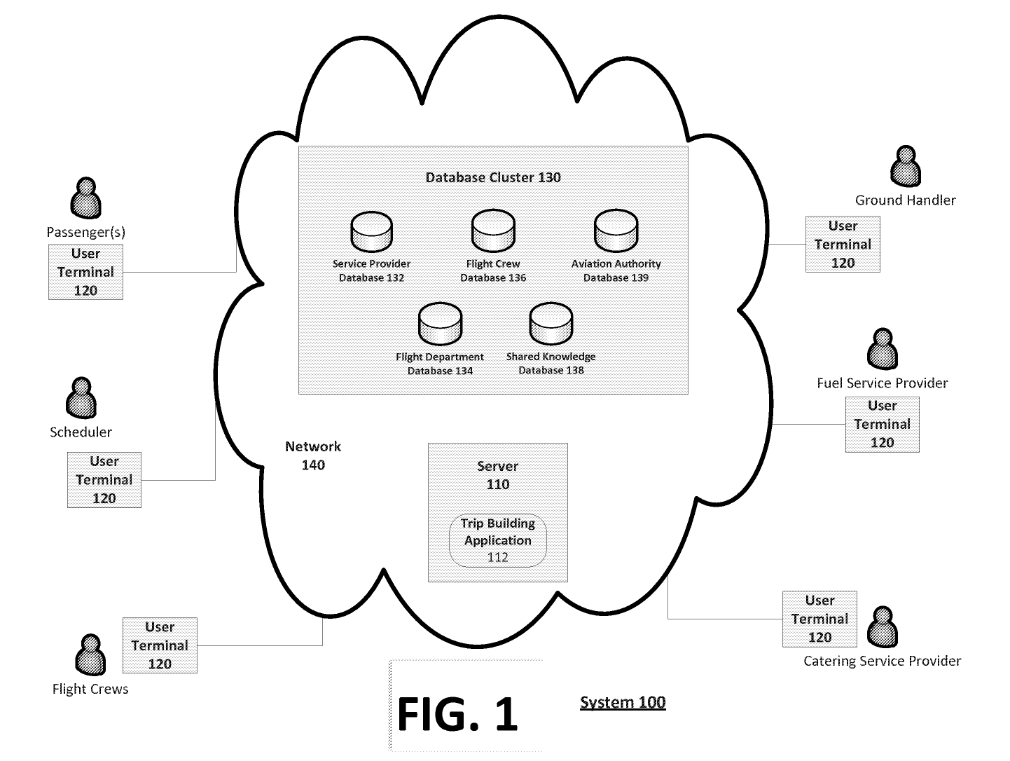

FIG. 1 illustrates an exemplary system for building an on-demand aviation trip, according to an embodiment of the present disclosure. The system 100 comprises a server 110, a plurality of user terminals 120 and a database cluster 130. The server 110 implements a trip building application 112 configured to carry out various functions described above, such as generating trip requirement data and the service provider data. Although a single server 110 is used to implement the trip building application in FIG. 1, one of skill in the art will recognize that multiple servers may be used to implement the trip building application 112 to improve the performance of the entire system.

As mentioned above, authorized individuals and entities related in building the trip can interact and communicate with the trip building application 112 via a user terminal 120. The user terminal 120 may be implemented using hardware, software, firmware, or tangible computer readable media having instructions stored thereon. As shown in FIG. 1, the user terminal 120 can be implemented in stationary computing devices (e.g., personal computer, workstation) as well as mobile devices (e.g., tablet, laptop, mobile phone). It is sufficient that the device implementing the user terminal can communicate with the trip building application 112 on the server 110 via the network 140.

The trip building application 112 is a server-side application that operates in the remote server, and all data generated by the trip building application is stored in the cloud. With this setting, even devices with limited processing power and functionality can be used to implement the user terminal 120. This configuration provides cross-platform and device independent system. In other words, individuals and entities relevant to the trip are not tied to a single designated user terminal, and allowed to access the trip building application 112 anywhere with any network enabled device. Passengers/schedulers can build a trip or request specific services using his smart TV at home, flight crews can receive and view flight schedules using an application installed on their iPhone®, service providers can receive service request and send confirmation using their laptops, and even changes to the trip can be made inflight by the passenger using any device of his choice.

The user terminal can be proprietary software (e.g. dedicated iOS® application, general PC installable software) or any conventional web browser (e.g., Internet Explorer by Microsoft, Inc., Chrome by Google, Inc., Safari by Apple, Inc.). Since the user terminal is not intended to perform any processor intensive or resource heavy tasks, it is sufficient that user terminal allows the users to access the trip building application 112 implemented on the server 110.

As shown in FIG. 1, the database cluster 130 includes a service provider database 132. The service provider database 132 contains information regarding service providers that may be able to fulfill service requirements. It should be reminded that providing the ability to fully customize the trip by allowing the user to select desired service provider for each service requirement is one of the objectives of present invention. Accordingly, the service provider database 132 may store information of many different types of service providers, including catering service providers, ground transportation service providers, lodging service providers, fuel service providers, as well as FBOs.

The information stored in the service provider database 132 ranges from the basic information, for example, type of services and geographical region (e.g., specific airport or the nearby cities) served by the service provider to various supplemental information including, but not limited to, user review, service rating, certification status, affiliation with certain entity, compliance status, insurance coverage level, and/or special terms and limitations.

Although many service providers are typically located at or near airports to provide on-site services, some service providers provide location irrelevant services. Flight plan vendors that provide optimized flight plans to the scheduler or staffing agencies that provide full/part-time flight crews and AMTs are just a few examples of location irrelevant service services. Moreover, increasing numbers of service providers that were traditionally considered as airport specific now operate globally, offering services in multiple airports throughout the world. For this reason, maintaining the service provider database 132 based on the geographic location of airports should be avoided.

Although a single server 110 is used to implement the trip building application 112 in FIG. 1, functionalities of the trip building application 112 may be implemented with multiple discrete servers. Likewise, the service provider database 132 may be implemented with multiple discrete databases to improve reliability or other factors. In one embodiment, the service provider database 132 is implemented in the server 110 and integrated with the trip building application 112. In addition, the trip building system 100 may further include various additional applications modules and databases such as the flight department database 134, the flight crew database 136 which will be discussed in detail below.

### Exemplary User Interface

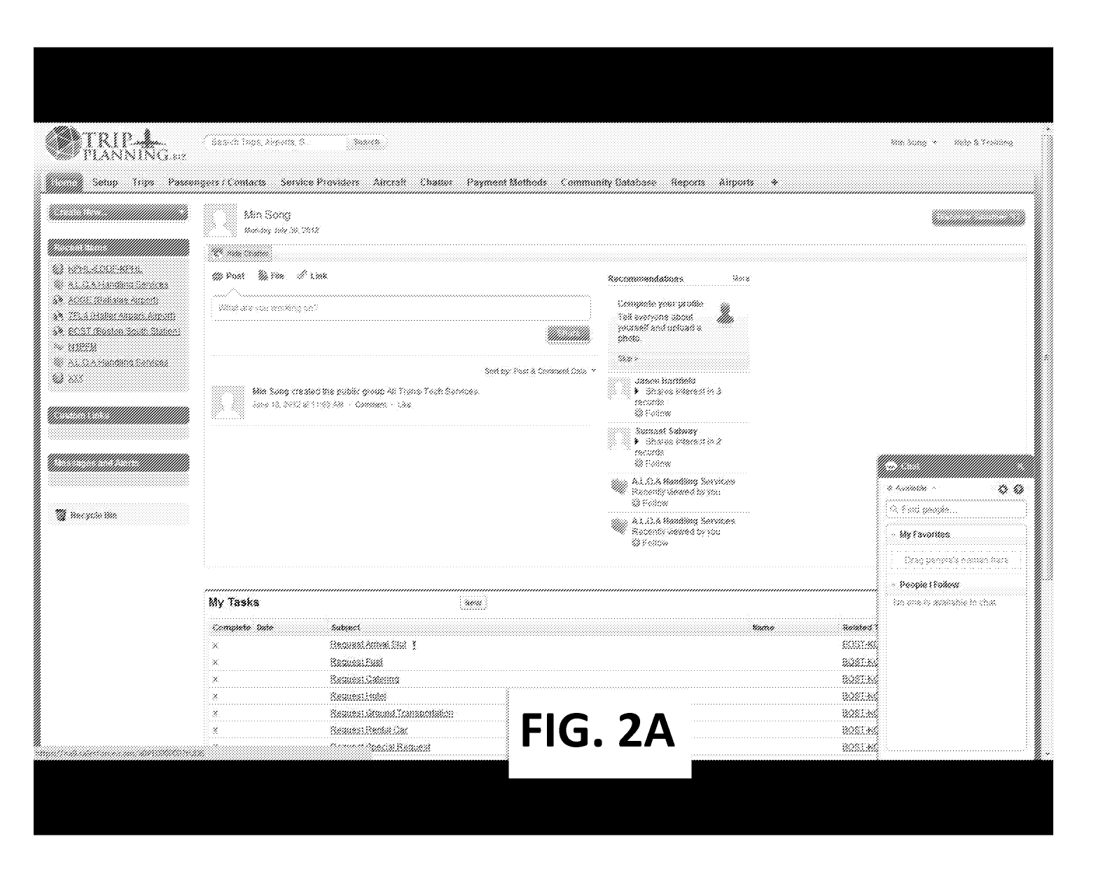

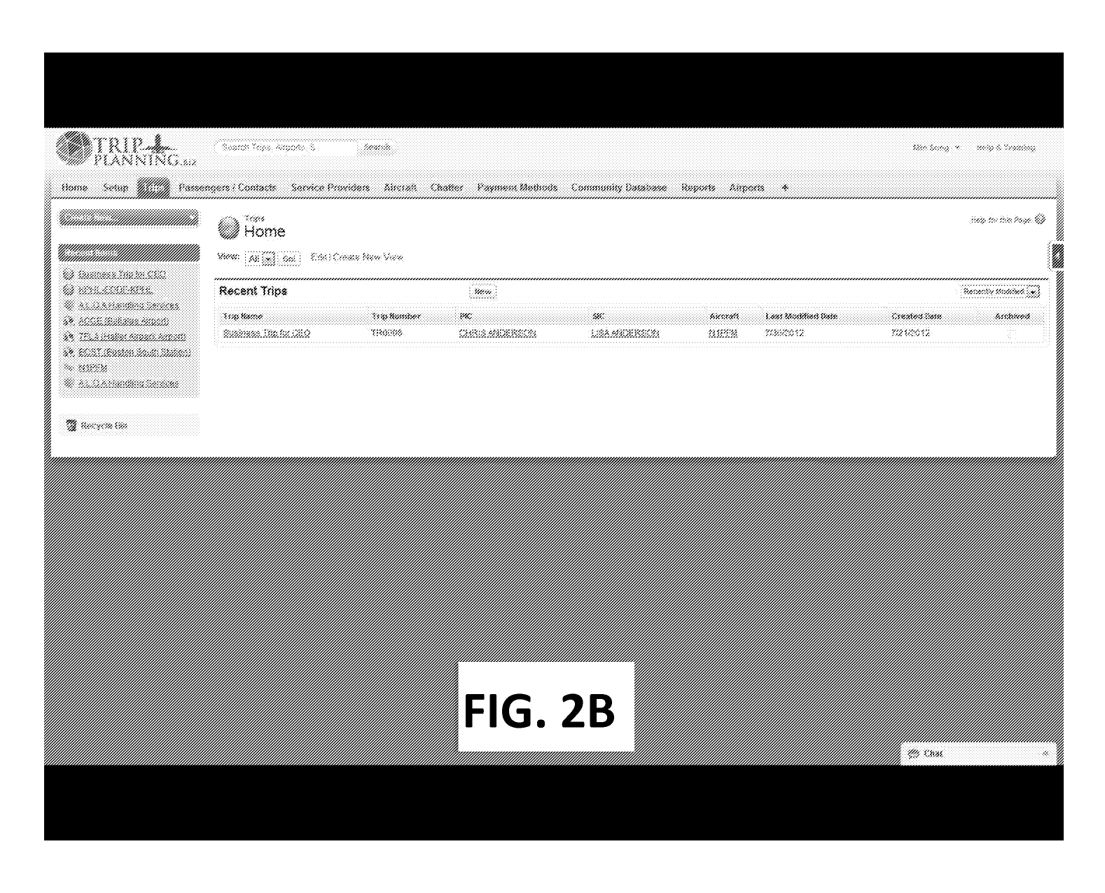

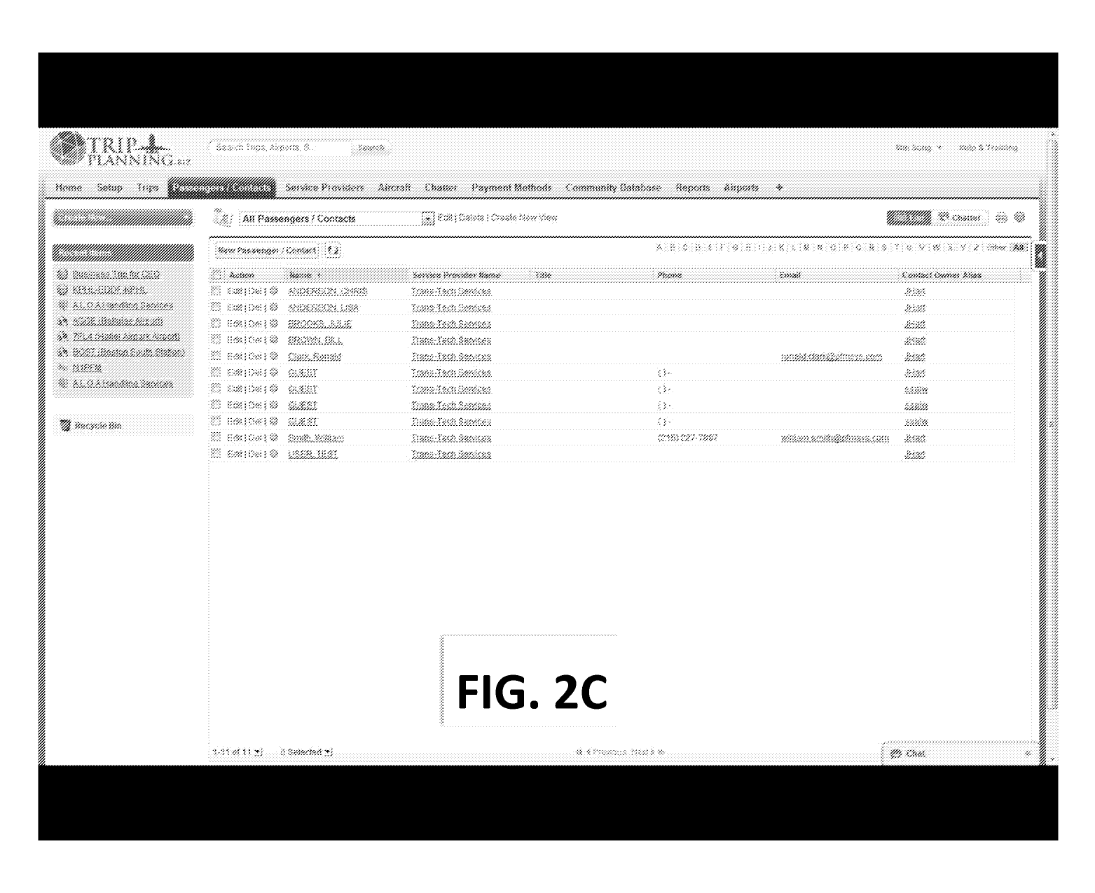

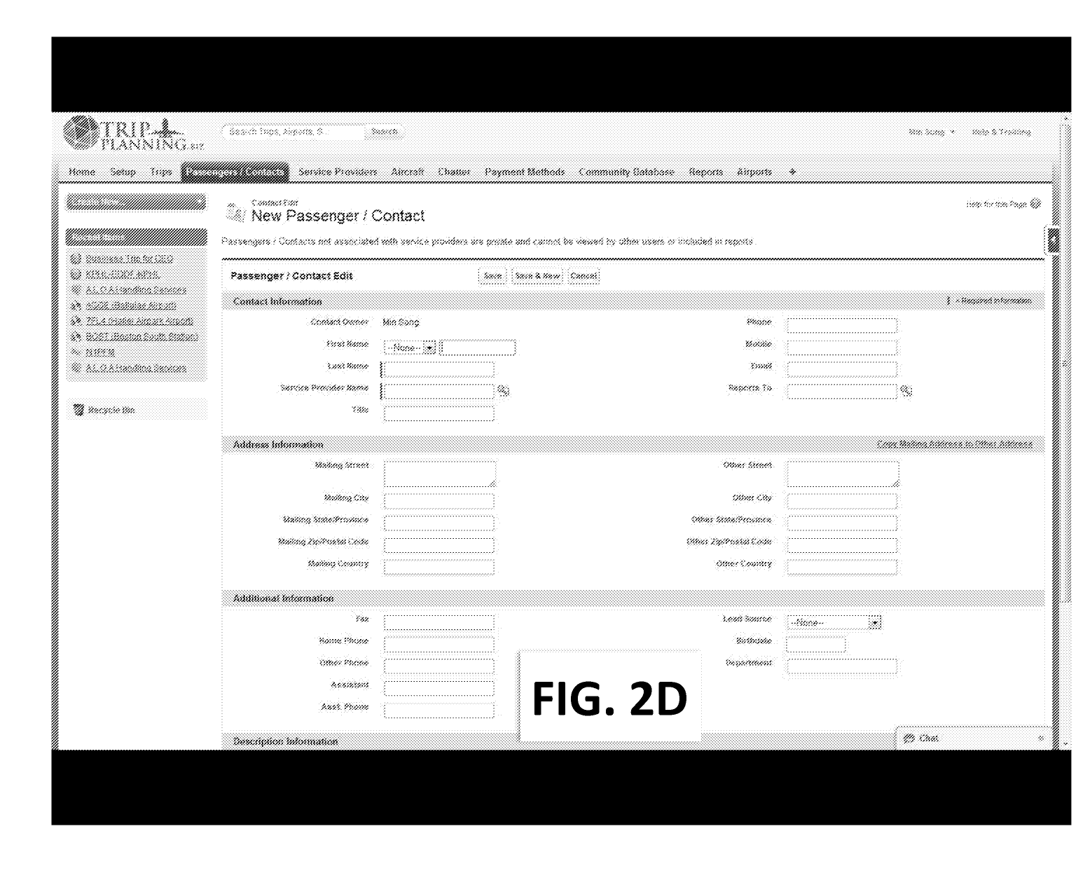

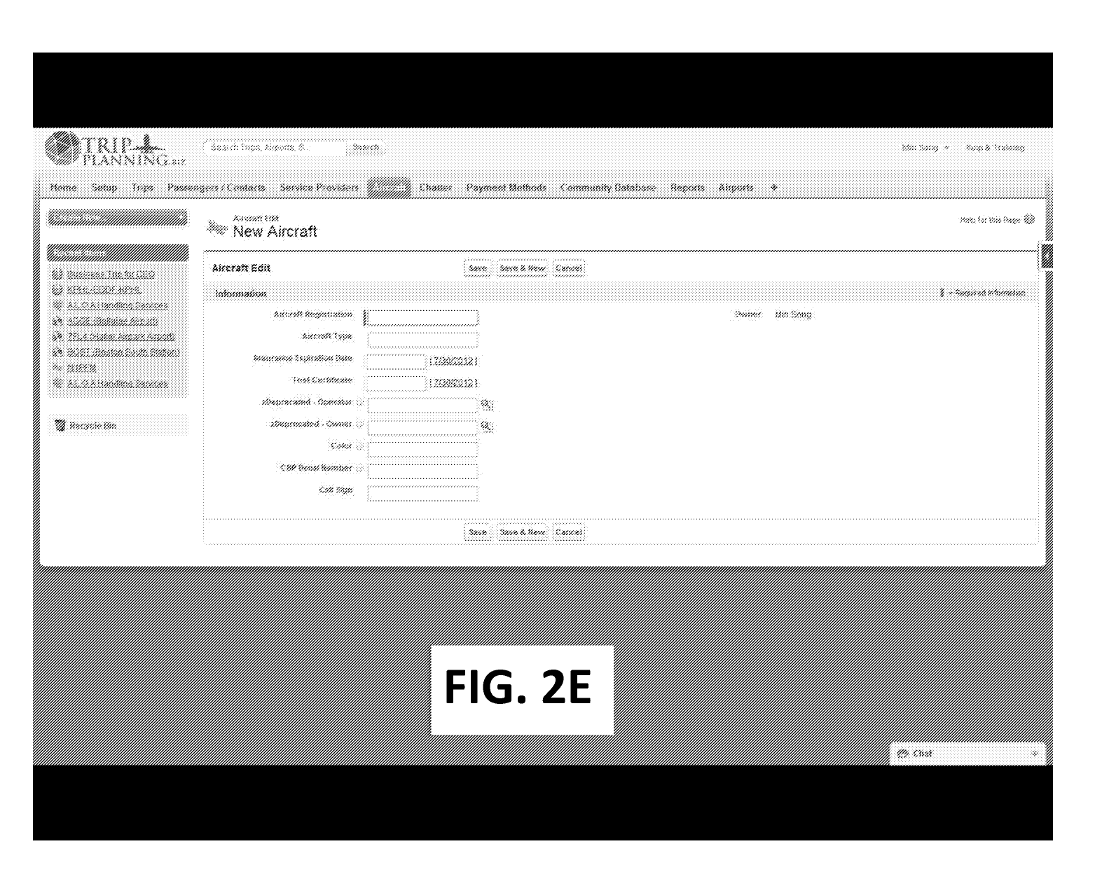

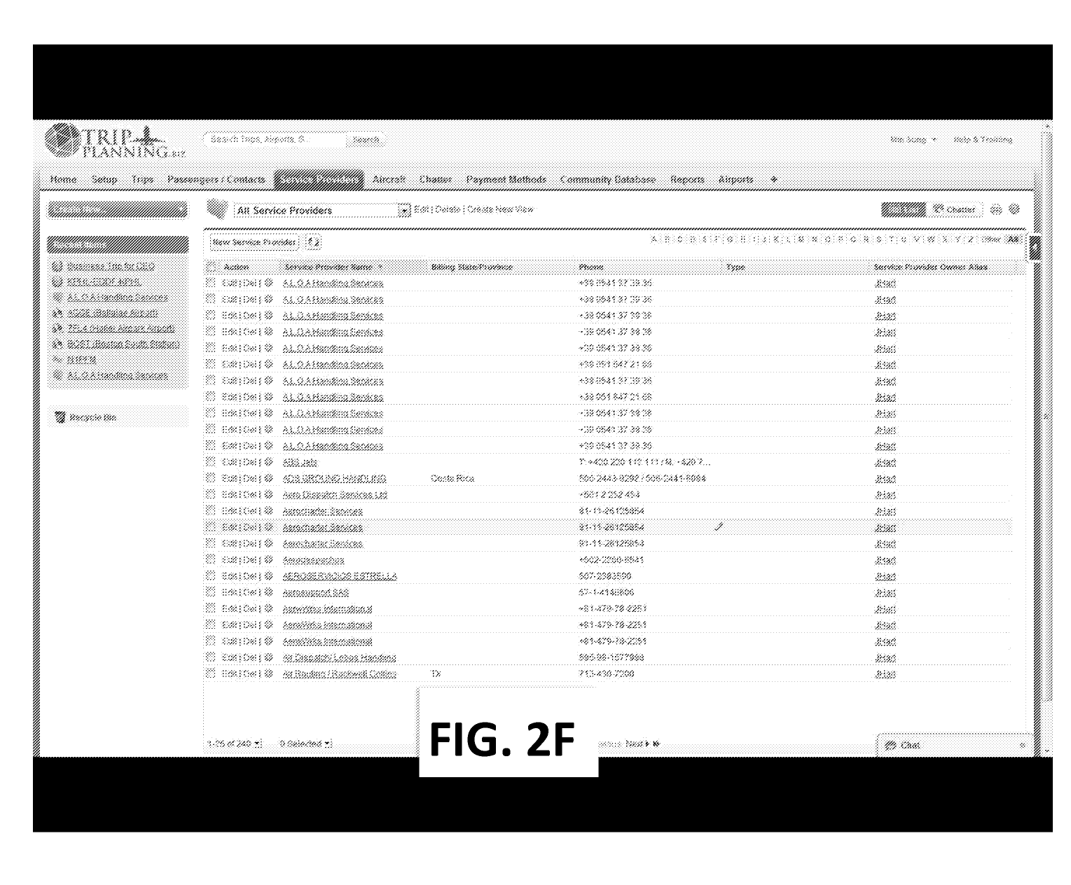

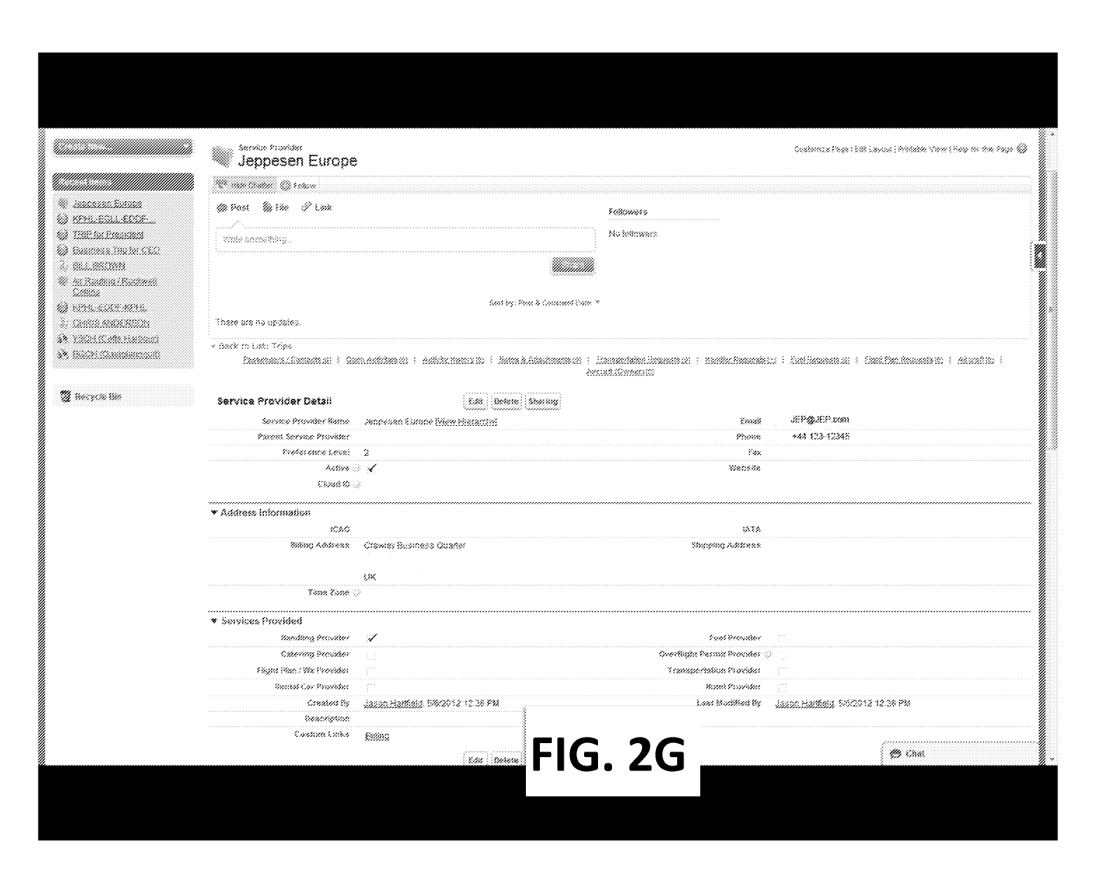

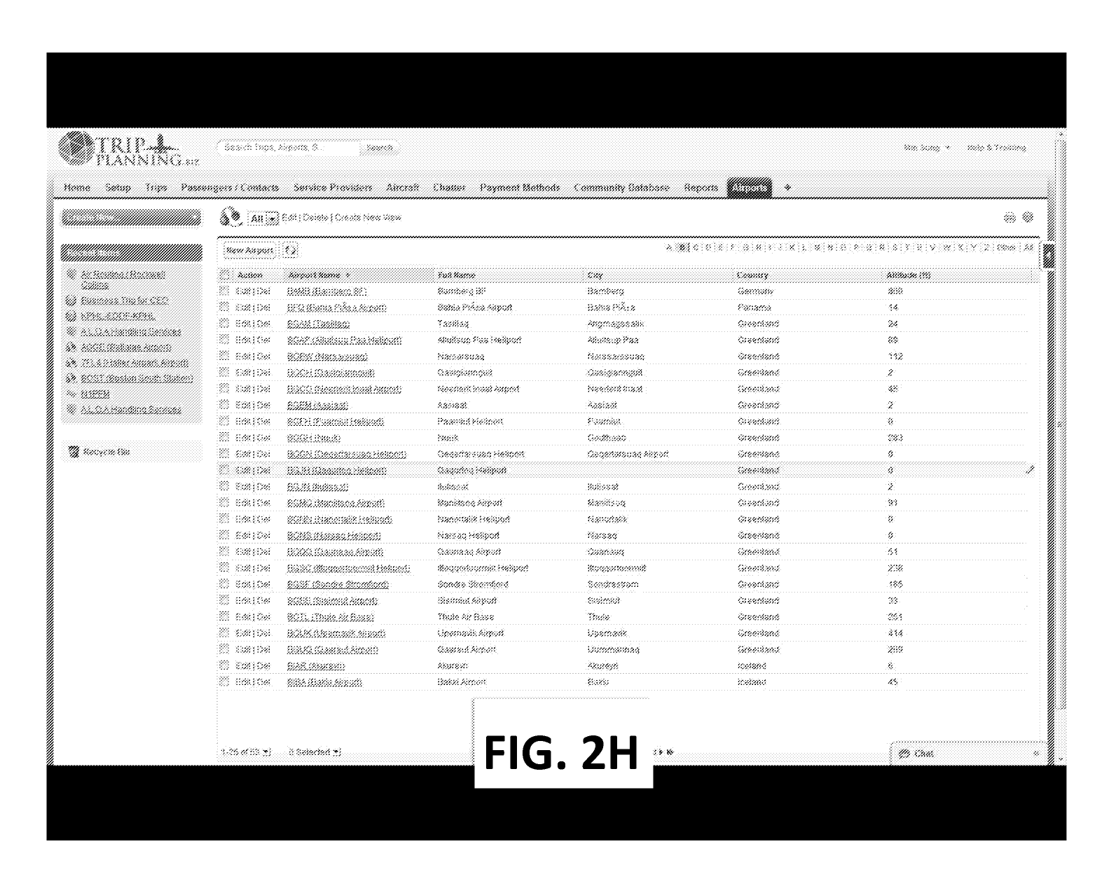

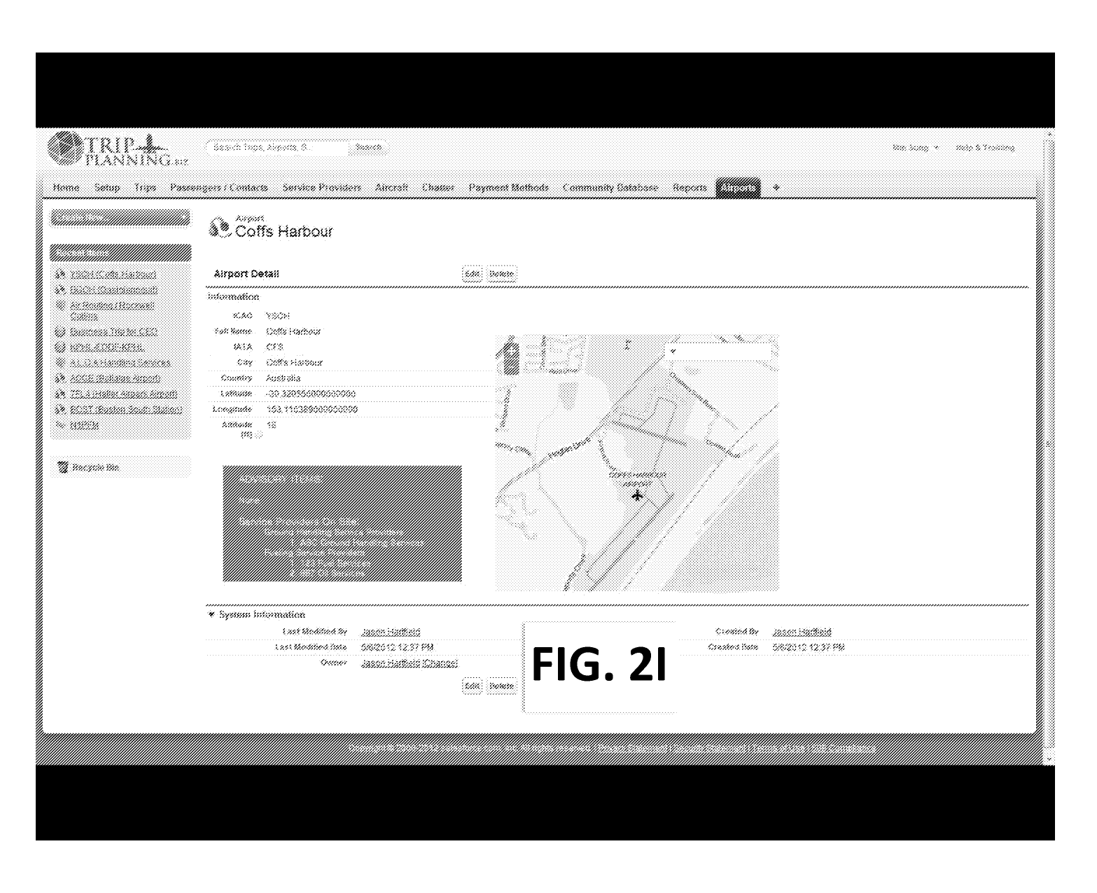

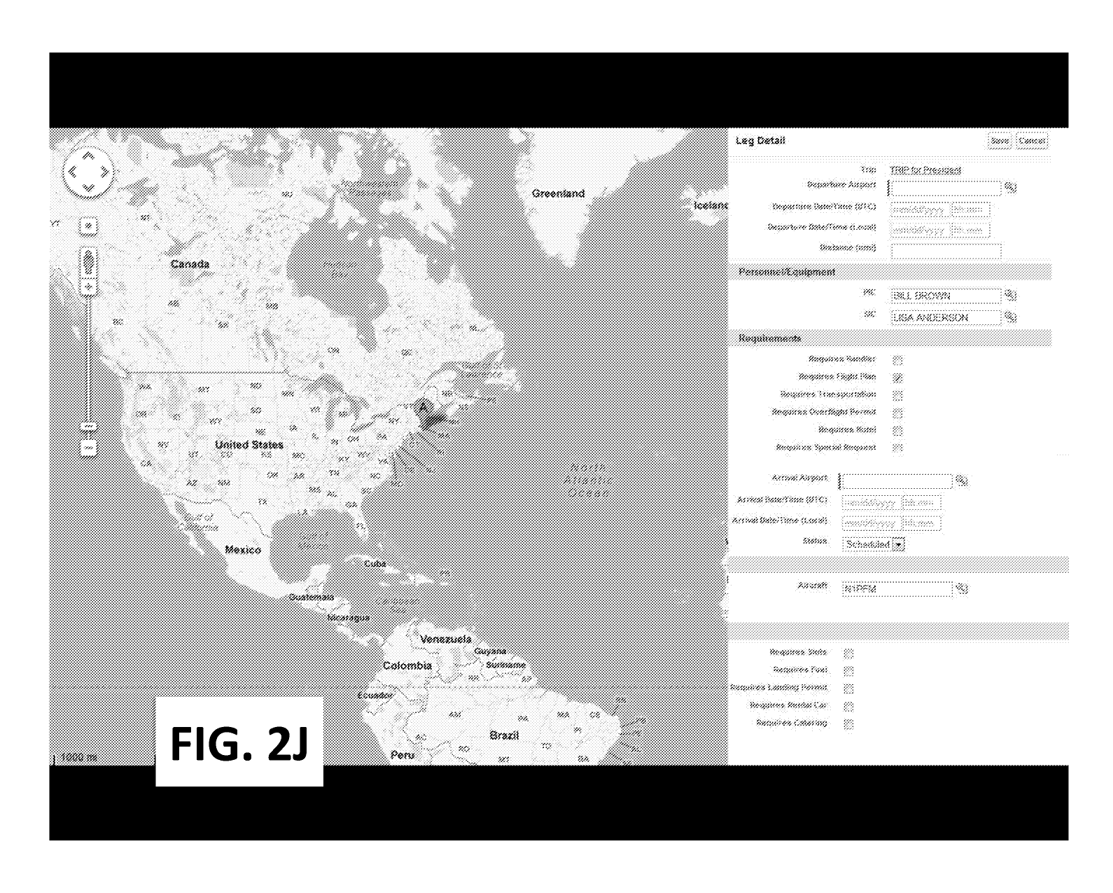

As described above, the scheduler can access the trip building application 112 by using the user terminal 120, such as a conventional web browser, to build a trip. Any registered user will have a set of ID and Password to access the trip building application 112 with corresponding user interface and access privilege. Upon logging in, the scheduler may be presented with an exemplary graphical user interface (“GUI”) as shown in FIG. 2A.

As shown in FIG. 2A, the user interface may include a tab having a number of links to different parts of the trip building application 112, each providing different layouts and functionalities. The “Home” button takes the scheduler to the main page tailored for the individual accessing the trip building application. This page may function as a personal dashboard, allowing the user to communicate other registered users, receive message and alert notifications, and keep track of scheduled meeting or request meeting with others. As shown, the “Home” page of a scheduler contains a task pane, which shows a list of tasks that are related to the trip(s) being built. The tasks in the list can be filtered and sorted by associated trip, status or due date of the tasks. In addition, a button for creating a new trip as well as a customized task may be provided.

It should be noted that a scheduler may need to build and manage multiple trips at once. FIG. 2B is a screenshot of an exemplary “Trip” page, which contains a list of trips that is being built by the scheduler or currently in progress. FIG. 2C is a screenshot of an exemplary “Passengers/Contracts” page, which allows the scheduler to manually enter detailed information about the passengers or the service providers, as shown in FIG. 2D. Similarly, FIG. 2E is a screenshot of an exemplary “Aircraft” page, which allows the scheduler to view, manage and manually enter and manage information regarding the aircrafts operated by the flight department.

Any manually entered service provider information in the “Passengers/Contracts” page may be added to the service provider database 132 depicted in FIG. 1. Also, the information regarding the passengers and aircraft is preferably stored in the flight department database 134 depicted in FIG. 1. The flight department database 134 may further store additional flight department specific information of many companies, including their payment methods, preferred service providers, preferred services, preferred airports, maximum price for certain service requirement, minimum quality requirement, and any various other criteria preset by the flight departments. Information concerning the past trips of flight departments can also be stored in the flight department data 134, and used when generating various reports for the flight department, which may be offered in the “Reports” page. The system may be configured to automatically recognize trip building patterns of each flight department to improve accuracy of automated tasks handling features discusses in the present disclosure. However, the information stored in the flight department database 134 is confidential, and thus, should not be shared with anyone other than the users of that particular flight department (e.g., authorized employees of the flight department). In any case, it is imperative that the service providers are prevented from obtaining information regarding the flight department's preferences, criteria and the trip building pattern. With such information, service providers can easily devise a pricing strategy to be used on particular flight department, which would defeat the purpose of present invention.

FIG. 2F is a screenshot of an exemplary “Service Providers” page, which allows the scheduler to search and view information regarding service providers stored the service provider database 132. “Go” button is provided to present a listing of service providers. Detailed information regarding a particular service provider is provided upon a selection as shown in FIG. 2G. It should be reminded that some service providers may have been manually entered to the service provider database 132 by the scheduler or may have been searched from the Internet and entered by the system. Accordingly, some information regarding some service providers may not be as detailed information as the information regarding the registered service providers that may have supplied information themselves.

FIG. 2H is a screenshot of an exemplary “Airports” page, which allows the scheduler to search and view information regarding particular airport. When a particular airport is selected, detailed information of the airport is provided as shown in FIG. 2I. The system may be configured to retrieve additional information (e.g., advisory actions, news) relevant to the selected airport from an aviation authority to present such information along with the items shown in FIG. 2I.

The user interface for the scheduler may further contain links to “Community Database” page, which will be discussed later in the present disclosure.

### Exemplary Method

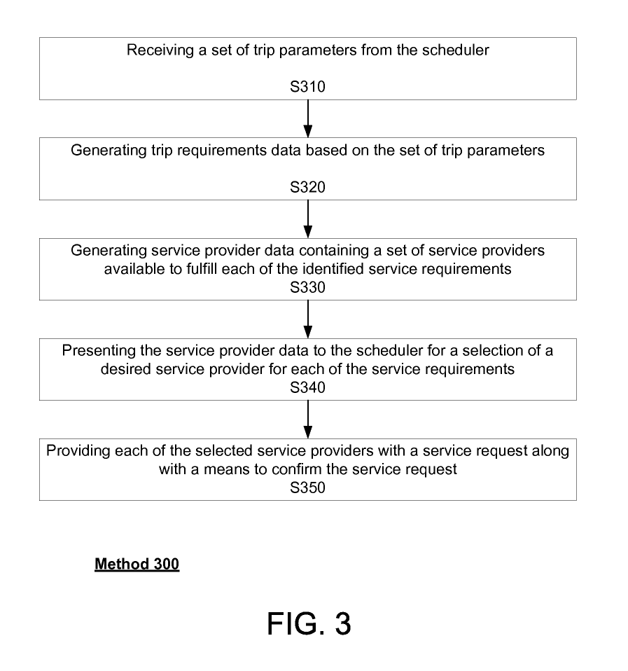

FIG. 3 illustrates a flowchart of an exemplary method for building an on-demand aviation trip. In S310, a set of trip parameters are provided to the trip building application 112 from the scheduler. The set of trip parameters may include, but are not limited to, trip scheduling elements, such as name of person making the request and authorizing the trip, purpose of trip, dates of trip, destination(s), as well as names of passengers. It is preferred that the set of trip parameters comprises at least the parameters for indicating the departing location and destination location as well as the schedule (e.g., date/time) for the trip.

Referring to FIG. 2J, an exemplary trip creation interface containing an interactive map is shown. The interactive map interface allows the scheduler to simply select a departure location and a destination location via any available input device (e.g., mouse, touch screen). In addition to selecting each location individually, the interactive map interface also allows the scheduler to simply draw a line from one location to another to define the departure and destination locations, and to drag an existing line to yet another location to define multiple legs of the trip.

It should be noted that the departure location and the destination location are not limited to the airports, but any locations, for example, home or office, can be selected. The system can automatically select an airport closest to the selected locations. If multiple airports exist within or near the selected locations, the user interface may present those airports and prompts the scheduler to select a desired airport. Not only does this feature simplifies the process for the user to define the trip, but the actual origin and destination information can be used during the trip building process to assist the user in greater detail. For example, such information can be used in to during searching of a suitable ground transportation services, lodging services, or any other special service request specified by the scheduler or the passenger. Further, projected time for traveling between the actual destination and the airport can be used to select or suggest different airport, depending on the time constraint of the following legs of the trip.

In addition to the interactive map, the trip creation interface may also contain a number of fields and buttons for the scheduler to provide other trip parameters with respect to various aspects of the trip. One of skill in the art will recognize that the trip parameters may also include a variety of other attributes and data not listed above. It is sufficient that the trip parameters specify any aspects and/or information related to the trip being built, and they are recognizable by the system of the present invention. Although the system will automatically identify the service requirements for the trip, the trip creation interface may allow the scheduler to initially specify desired service requirements. When the trip has multiple legs (i.e., departing airport and destination airport), the scheduler may be required or prompted with an option to further specify parameters for each leg of the trip.

Referring back to FIG. 3, in S320, trip requirements data is generated by the system based on the set of trip parameters defined by the user. The trip requirements data identifies a set of service requirements for the trip. Some service requirements, such as regulatory aircraft maintenance, pre-flight fueling of the aircraft and ground handling at the destination airport, may be routine services that are always necessary in any trip. Some service requirements may have been manually selected by the scheduler at the time of trip creation as discussed above, and some may be pre-configured for the trips being built for particular flight department for certain destinations and/or for certain passengers.

Automatic verification and identification of service requirements from the set of parameters provided is another feature of the system disclosed in the present disclosure. For example, the set of trip parameters may have indicated a departure airport, a destination airport and desired time/date of the trip, and such information can be used by the system to obtain additional information from a variety of information sources. In doing so, some information may be obtained from various databases interconnected in the system. For instance, information regarding the availability of aircraft and flight crews as well as their duty time limitation can be retrieved from the flight department database 134 and the flight crew database 136, respectively. Some information, for example, weather forecast, overflying limitations, projected duration of ground transportation between the airport and the actual destination, may be retrieved from various third party online sources.

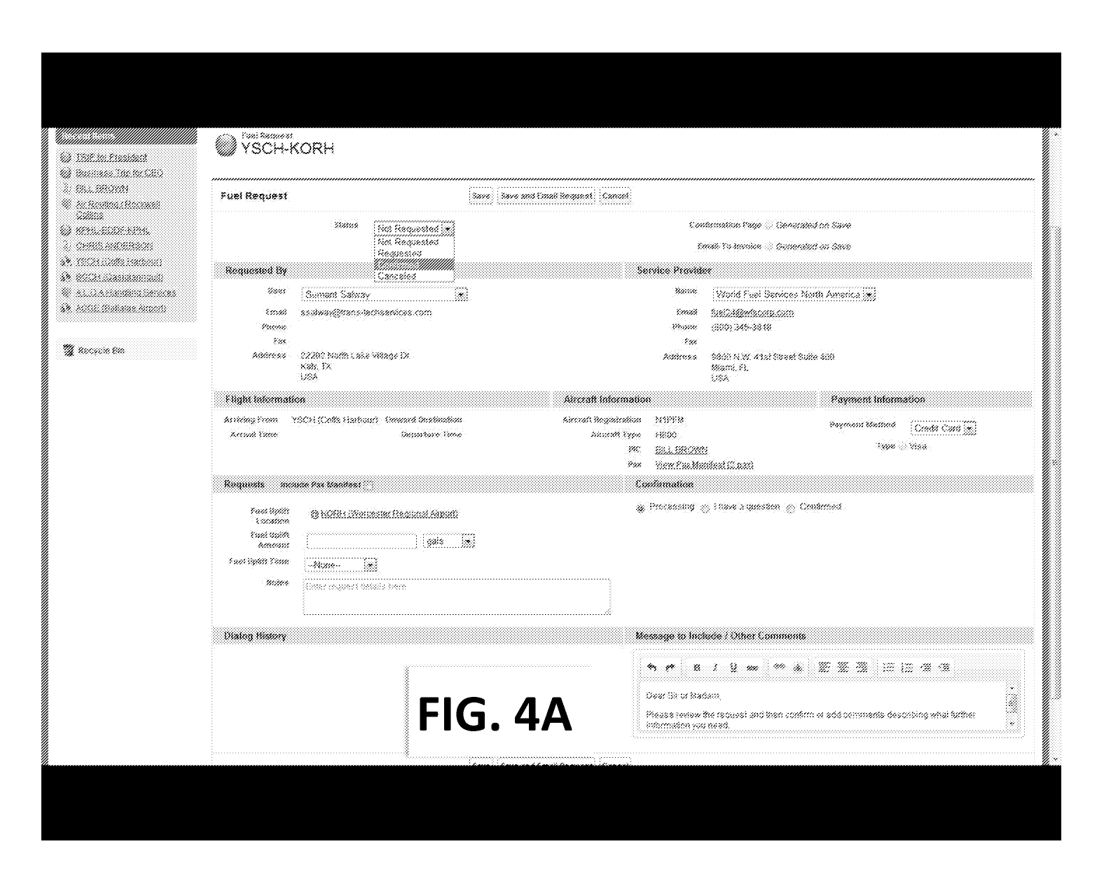

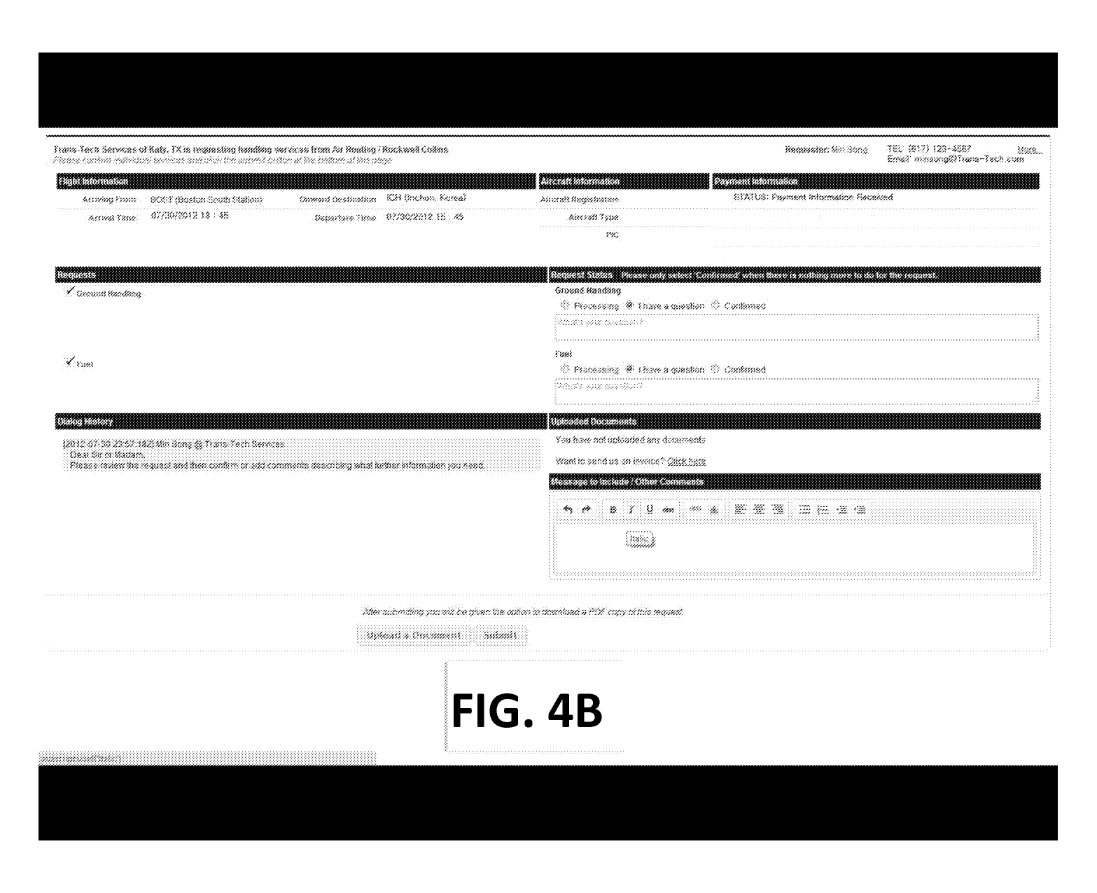

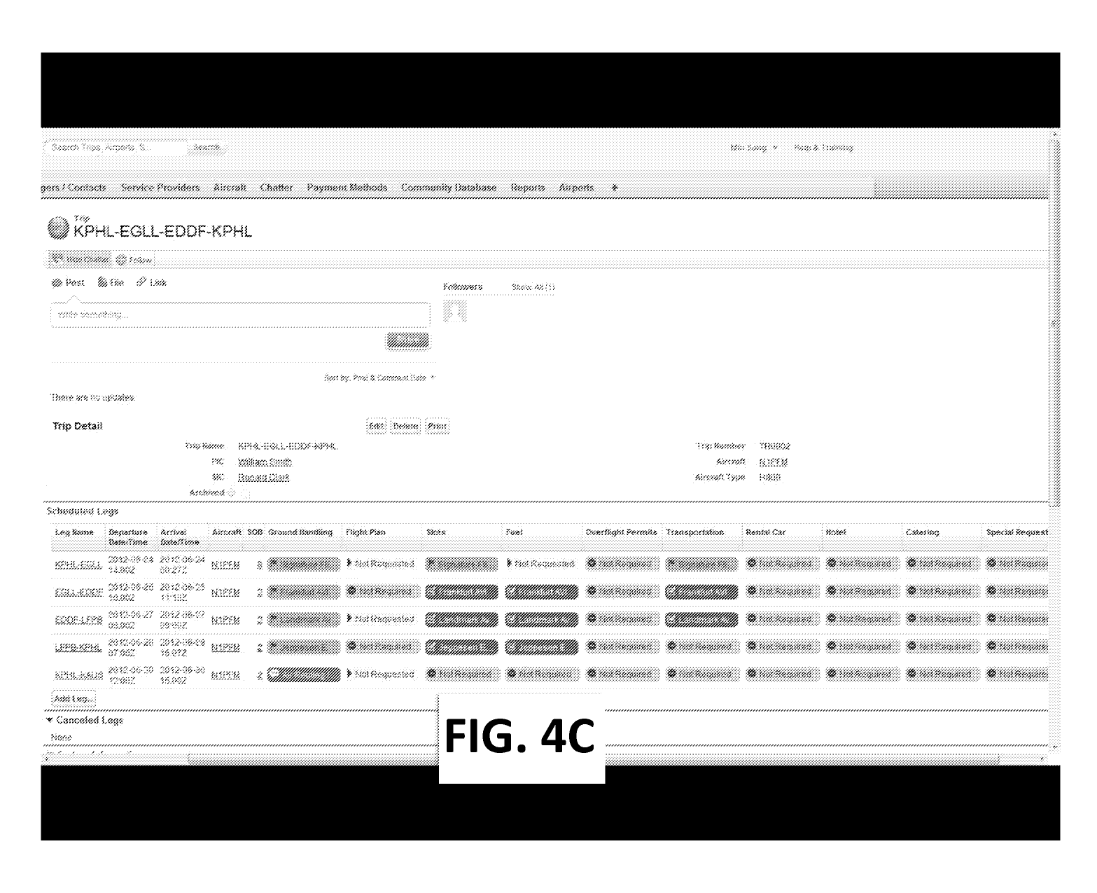

Additionally, some information that cannot be obtained fully automated fashion may be obtained from various users of the system. The system may provide a prompt on the user terminal of a flight crew to provide a number of ancillary information in order to obtain the flight plan for the trip. FIG. 4A is an exemplary user interface that may be presented to a flight crew (e.g., pilot in command) or directly to a service provider (e.g., flight plan vendor), according to an embodiment of present disclosure. As shown, the user interface allows to provide, or to edit, a number of ancillary information, such as cruise altitude, cruising speed, climb, descent, payload weight, reserve fuel, holding fuel, minimum fuel to alternate airport, tax out fuel and fuel on board. Some of the information may have been prepopulated by the system, and the PIC is provided with an option to directly provide the flight trip or to populate any missing ancillary information, select a service provider and submit the flight plan request to the selected flight plan vendor.

In some embodiments, the system may be equipped with specific software modules to generate necessary information to speed up the process. For instance, the departure-destination locations, weather forecast and aircraft information may be provided to a flight plan generation module along with the aforementioned ancillary information to generate an optimized flight plan.

Any of the aforementioned trip parameters, information stored in the databases, and information gathered from various online sources can be used by the system to identify additional service requirements for the trip or to correct the service requirements previously selected by the user. For instance, the distance of a leg in the trip may be too far for the available aircraft and the fuel, thereby requiring a fuel service requirement at the origin or an additional leg in between the leg with a fuel service requirement. As will be discussed in further detail below, in an embodiment, the trip requirement data may also identify a set of clearances required for the trip, which may be determined in similar fashion as described here.

In addition to identifying or correcting the service requirements/clearance requirements for the trip, newly obtained information can also be used to suggest alternative trip schedule for the user. For instance, it may be more economical or safe to land at a different airport near the destination, adjust the flight plan (e.g., flight route), or even switch legs in the trip based on various reasons like adverse weather condition forecast, availability of take-off/landing slots as well as unusually high price difference in fuel between airports surrounding the destination. In such cases, the system may automatically provide an alternate trip plan to the scheduler or the passenger for consideration. One of skill in the art will recognize that various types of additional information can be deduced by the system from the trip parameters, data/information and informational sources discussed above, and used by the system to further optimize the service requirements and the clearance requirements for the trip.

Referring back to FIG. 3, once the trip requirement data is generated, the system generates service provider data containing a set of service providers available to fulfill each of the identified service requirements as in S330. The service provider data is generated by the system based on the set of trip parameters, the additional information gathered by the system, as well as information retrieved from various information sources described above. For example, the system may communicate with a service provider database 132 to retrieve a list of fuel vendors stationed at the airport scheduled to land for fulfilling the fuel service requirement for the trip. Service provider data for other types of service requirements, for instance, catering or ground transportation, can be generated in a similar fashion. Of course, the service provider data can be generated to contain a set of FBOs available at certain airport, so that the scheduler/passenger can compare the pros and cons of bundled service offered by FBOs, or to select a FBO if no other service provider is available.

For some service requirements, significantly more number of service providers may be available online. Accordingly, in an embodiment, the system may search the Internet for service providers, for example, catering service providers or limousine service providers, and include the search result in the service provider data. It should be understood that any information sources described above can be used in generating the service provider data for any service requirements.

Furthermore, the set of service providers for the service requirements can be pre-filtered if the trip parameter included some forms of preferences relating to the service requirements. For instance, preferences for specific brands, price ranges, service provider with specific certification, service rating, affiliation or level of insurance coverage, and the likes, indicated by the scheduler may be used to filter the service providers before presented to the scheduler.

In some embodiments, the system may be configured to initiate preliminary check for the availability to provide the service requirement at the designated schedule by sending automated messages (e.g., automated voice call, auto-generated email) and seeking confirmation for availability. In addition to verifying the availability, the automated message may also provide opportunity for the service providers to submit or update their information in the service provider database 132. This way, the integrity and the size of the service provider database 132 can be improved.

In an embodiment, the trip building application 112 is configured to facilitate an online bidding among the service providers for each of the service requirements. In this setting, a group of service providers that may be available or confirmed to be available to fulfill the particular service requirement are provided with a request to submit a bid for the service requirement. Preferably, the bids submitted by the service providers are shared within the group of service providers, thereby promoting competition among the service providers. Submitted bids prices may be simply integrated into the service provider data to be presented to the scheduler. Alternatively, a specific bid submission deadline may be set and the system may be configured to use the bid prices at the end of the auction to automatically select a service provider for the service requirement.

In S340, the service provider data is presented to the scheduler for a selection of a desired service provider for each of the service requirements. The system has provided a set of service requirements for the trip along with the list of service providers available to fulfill those requirements. The scheduler “builds” the trip by simply making a final selection for a service provider for each of the service requirements. In some embodiments, the trip building application may be configured to provide suggestions to the scheduler or to automatically select the ideal service provider for each service requirement to further automate the trip building process.

### Shared Knowledge Database

As was shown in FIG. 2G, the scheduler may be able to view detailed information regarding the presented service providers before making the final selection for the service provider. Information stored in the shared knowledge database 138, such as user reviews and average service rating data of service providers can be particularly helpful in deciding the service provider. The reviews and rating on other service providers are obtained from any registered users of the system, including the passengers, the schedulers, the flight crews and the service providers. In an embodiment, the passengers, flight crews, and the schedulers are prompted to provide feedback data, such as review and service rate for the service provider after the service is rendered or at the end of the entire trip, which are stored in the shared knowledge database 138. The service providers may also provide responses back to the reviews and stored with reference to particular review or rating given. The service provider may also use the shared knowledge database 138 to advertise their services. While service providers may be able to view and actively participate in compiling the information in the shared knowledge database 138, any service providers supplied information should be specially marked to provide unbiased information to the schedulers.

In S350, each of the selected service providers is provided with a service request along with a means to confirm the service request. A real-time notification may be provided on the user terminal of the selected service provider to view the details of service request and to confirm the request. For those service providers not registered in the system (i.e., service providers not included in the service provider database), the request may be provided in the similar fashion as the availability verification message described above. For example, the system may provide an automated voice call to the selected service provider to notify the service request and make a request to confirm the service request. Also, the system may send the service request to the selected service provider's email address, and the email may contain a link for the service provider to view and confirm the service request or to register in the system to view and confirm the service request. The service request may be provided in the suitable language, based on the known location of the service provider.

FIG. 4B shows a screenshot of an exemplary service request presented to the service provider. In this example, the service request is made for fueling service. The service request shows basic flight information (e.g., requester's contact information, arrival time, departure time) and aircraft information (e.g., aircraft type, aircraft registration number). The service request contains a “Request” section providing information relevant to the requested service. For fueling service, the “Request” section may provide the location to uplift the fuel, the amount needed, and the timeframe for the fuel uplift service. Any special note provided by the user can also be included in the “Request” section. As previously discussed, all information in the service request, except for the note from the user, should be populated by the system.

“Confirmation” section of the request allows the service provider to either confirm the service request or to request additional information from the scheduler. The service provider can request additional information by simply entering text message in the provided text box or by uploading any electronic files, including audio, video, text or any recognizable data file to the server. The chain of communication between the user and the service provider is maintained the “Dialog History” section of the service request along with the link to the uploaded file. The uploaded file can be checked for any sign of computer virus or malware, and made available to the service requester (e.g., scheduler, passenger, flight crew member).

When entering the message or uploading the file, the service provider may be prompted to select the type of additional information being requested. For example, the service provider may indicate “need additional parameter”, “need confirmation on the quoted price”, “need confirmation on the terms and services agreement” and the likes. Depending on the type, a parse module may be used to parse the message or the uploaded file to automatically respond back to the service provider with the corresponding information. For instance, the service provider may require a selection for a specific type of fuel, and the system may automatically answer back to the service provider based on the preference pre-configured by the particular scheduler. For some questions that cannot be answered by the system, the system may notify the scheduler about the additional question from the service provider. Further, the parsed information may be stored in the service provider database 132 so that the system can automatically include provide information to any future service request made to that particular service provider. Methods for parsing text and speech are well known in the art, and any conventional natural language parsing techniques, optical character recognition and speech recognition technique can be employed.

If no additional information required by the service provider, the service provider can simply confirm the service request, and the system will automatically change the status of that service requirement as confirmed and alert the user of the change.

Regardless of the method used in sending the service request, the system is configured to periodically check and resend the service requests to those who failed to confirm the service request. In an embodiment, the system is configured to prompt the scheduler for a selection of an alternate service provider or to automatically select an alternate service provider, and send service request to the alternate service provider in the absence of confirmation from the initially selected service provider.

The scheduler is provided an interface showing detailed status overview of the trip as shown in FIG. 4C. This interface may be accessible by selecting a specific trip from the listed of trips shown in the “Trip” page. The trip status interface shows the basic trip information such as “Trip name”, “PIC”, “SIC”, “Trip Number” (specific trip identifier), “Aircraft” as well as the “Aircraft Type”. The trip will be marked as “archived” if the selected trip was an old trip that was completed trip in the past. In addition to the basic trip information, the trip status interface also shows the status of each trip requirements for each leg of the trip. For instance, the first leg of the trip requires ground handling, flight plan, landing slot reservation, fuel service and ground transportation. Each of the required items is denoted by the service provider name which was selected by the scheduler. The status of the requirements can also be indicated with special icons or by assigning different color code indicating different status.

For example, all items that have not been confirmed by the selected service provider may be marked with yellow, while all confirmed items are marked with green. If any additional information is requested by the service provider, such item can be marked with red, indicating that an immediate attention is needed by the scheduler (e.g., inquiry that must be answered by the scheduler). All non-required items are indicated as “Not required.” Using this interface, it is also possible for the scheduler to view all the communication between the scheduler and the specific service provider relating to the service requirement, or send another message to the service provider.

### Clearance Task Management

As briefly discussed above, the system may also identify and automatically send requests for various clearances that are required for the trip. Various domestic and international aviation related authorities, such as Federal Aviation Administration (“FAA”), Civil Aviation Authority (“CAA”), Air Traffic Control (“ATC”), International Civil Aviation Organization (“ICAO”) may require various types of clearances including, but are not limited to, overflying permit, landing permit and airworthiness certificate before the aircraft to be flown. Also, customs and immigration related agencies of many different countries may require various types of supporting documents for passengers and flight crews to enter the destination countries.

In an embodiment, the system includes an aviation authority database 139 containing request forms for the clearances in the format required by the respective aviation authority. The aviation authority database 139 may also store and periodically update the actual request forms provided from the aviation authorities. The system can use the flight plan, passenger/flight crew information (e.g., passport, visa, PAX) and actual flight route to determine the forms needed for the trip and automatically populate information in the forms, which are made available to the respective authorities by sending links or the actual forms. As was done in the service request, the clearance request forms can be electronically submitted by to the authorities, and the communications with each authority may be recorded with reference to the trip.

### Automated Recalibration

Any changes made to the trip are handled by the system in the similar fashion as the methods described above. As described above, the changes may be made by various individuals and entities for various reasons. Not only can the scheduler and passenger cancel or request additional services, but the service providers may also need to retract its service confirmation. Even the CAAs of individual countries or the ATC may require changes to the previously authorized flight route. Further, sudden change in weather condition is always a possibility.

In an embodiment, the system is configured to automatically re-calibrate the trip requirement data if any change is made to any of the confirmed trip requirement items or if any change is made to the trip after it is built and fully scheduled. Also, in some embodiments, the system may be periodically monitor some of the volatile information such as weather forecast or fuel price forecast, and either automatically recalibrate the trip requirement data or prompt the scheduler to consider recalibrating the trip requirement data. In re-calibrating the trip requirement data, the trip building application 112 may identify items that need to be adjusted, and send appropriate requests for cancelling or modifying the previously confirmed service requirements. New service requirement data is generated in accordance to the new service requirements for the trip, and provided to the scheduler to selection of a service provider, as discussed above. Likewise, the system may also automatically send various aviation authorities with requests for new clearances or amend the previously received clearances as needed.

### Payment Management System

In addition to the aforementioned functionalities, the system further provides a secured environment for processing payments to the service providers. Unlike the prior method of which the flight departments sends over the payment information (e.g., credit card number, banking information) directly to the service providers, the payment information is stored in the system, preferably in the flight department database 134 described above. Upon receiving an invoice or at the time of procuring the service by the service provider, the system may process the payment on the remote server, or on another discrete server separated from the server implementing the trip building application. The security sensitive information like the credit card number or bank information needs not be disclosed to the service providers via unsecured methods like email or fax.

Embodiments shown in FIGS. 1-4, or any part(s) or function(s) thereof, may be implemented using hardware, software modules, firmware, tangible computer readable media having instructions stored thereon, or a combination thereof and may be implemented in one or more computer systems or other processing systems.

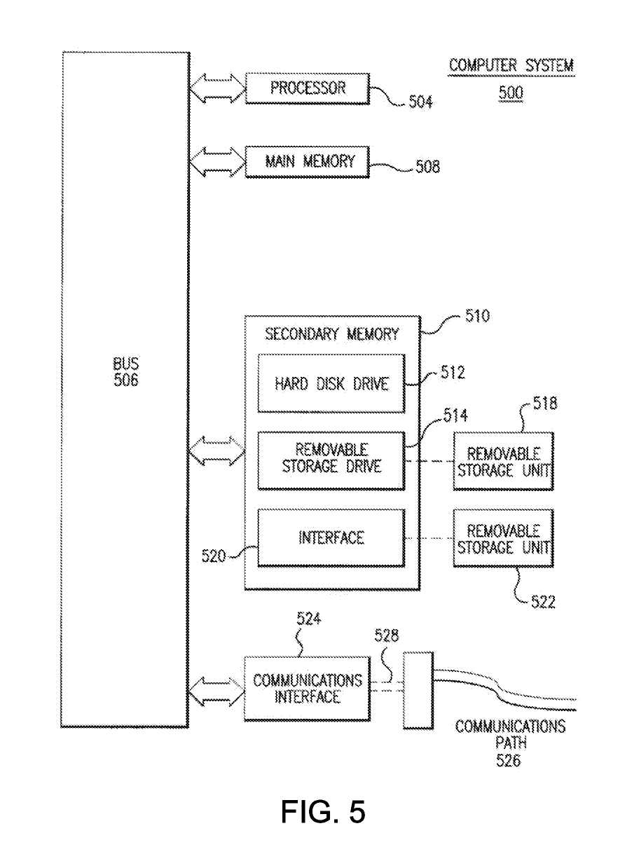

FIG. 5 illustrates an example computer system 500 in which embodiments, or portions thereof, may be implemented as computer-readable code. For example, trip building application 112 in FIG. 1, can be implemented in computer system 500 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-4.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 500. After reading this description, it will become apparent to a person skilled in the relevant art how to implement embodiments of the present invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device. As will be appreciated by persons skilled in the relevant art, processor device 504 may also be a single processor in a multi-core/multiprocessor system, such system operating alone, or in a cluster of computing devices operating in a cluster or server farm. Processor device 504 is connected to a communication infrastructure 506, for example, a bus, message queue, network, or multi-core message-passing scheme.

Computer system 500 also includes a main memory 508, for example, random access memory (RAM), and may also include a secondary memory 510. Secondary memory 510 may include, for example, a hard disk drive 512, removable storage drive 514. As will be appreciated by persons skilled in the relevant art, removable storage unit 518 includes a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 may be in the form of signals, which may be electronic, electromagnetic, optical, or other signals capable of being received by communications interface 524. These signals may be provided to communications interface 524 via a communications path 526. Communications path 526 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 518, removable storage unit 522, and a hard disk installed in hard disk drive 812. Computer program medium and computer usable medium may also refer to memories, such as main memory 508 and secondary memory 510, which may be memory semiconductors (e.g. DRAMs, etc.).

Computer programs (also called computer control logic) are stored in main memory 508 and/or secondary memory 510. Computer programs may also be received via communications interface 524. Such computer programs, when executed, enable computer system 500 to implement embodiments as discussed herein. In particular, the computer programs, when executed, enable processor device 504 to implement the processes of embodiments of the present invention, such as the stages in the methods illustrated by flowcharts 200 of FIG. 2, discussed above. Accordingly, such computer programs represent controllers of the computer system 500. Where embodiments are implemented using software, the software may be stored in a computer program product and loaded into computer system 500 using removable storage drive 514, interface 520, and hard disk drive 512, or communications interface 524.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.), and communication mediums (e.g., wired and wireless communications networks, local area networks, wide area networks, intranets, etc.).

### CONCLUSION

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of embodiments that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of building an on-demand aviation trip, comprising:
receiving one or more trip parameters from a user terminal of a scheduler via a network, wherein the trip parameters indicates at least one set of a departure location, a destination location, and a schedule for the trip;
generating a trip requirement data based on the trip parameters, wherein the trip requirement data comprises a service requirement data identifying one or more of service requirements for the trip;
generating service provider data containing one or more sets of available service providers corresponding to each of the identified service requirements; and
providing the service provider data to the scheduler for a selection of at least one service provider on each of the identified service requirements, wherein each of the selected service provider is provided with a respective service request and a request for a confirmation.

2. The method of claim 1 further comprising:
providing a bid submission request to one or more of the service providers in the set of service providers; and
receiving one or more bid submissions from one or more of the service providers, wherein the service provider data presented to the user terminal further includes the bids submitted from the respective service providers.

3. The method of claim 2, wherein the bids submitted from the service providers are disclosed among the set of service providers.

4. The method of claim 3, further comprising:
obtaining supplemental information regarding the service providers from a shared knowledge database, including one or more information on service level rating and user reviews with respect to the service providers, wherein the obtained information is included in the service provider data presented to the scheduler the set of service providers contained in the service provider data is filtered according to one or more of filtering parameters received from the scheduler, wherein said filtering parameters include a list of preferred service providers, a range of bid price, a required service level rating, a required number of user review, a required certification and a required compliance indication.

5. The method of claim 2, further comprising:
determining one or more flight crew requirements based on duration of flight, number of legs, flight condition, duration of the trip, duty time limitation;
obtaining a list of available flight crews for the trip from a flight crew database; and
either presenting the list of available flight crews to the scheduler to select one or more flight crews for the trip or automatically selecting one or more flight crews from the obtained list to satisfy the flight crew requirements, wherein each of the selected flight crew is provided with a request for a confirmation.

6. The method of claim 2, further comprising:
identifying one or more clearances required by one or more aviation authorities based on the flight route, flight plan, and passenger information;
retrieving one or more request forms for each of the required permits; and
automatically populating the request forms by retrieving necessary information from one or more information source, wherein each of the populated forms are made available to the corresponding aviation authorities with a request for a confirmation.

7. The method of claim 2, further comprising:
recalibrating the trip requirement data upon identifying any substantial changes to the existing trip; and
generating new service requirement data containing a set of service providers that require either new or an update on the existing service requests based on the recalibrated trip requirement data, wherein each service provider in the set is provided with a respective service request and a request for a confirmation.

8. The method of claim 2, further comprising:
periodically providing one or more reminder alerts to any individuals due for at least one confirmation, wherein said individuals includes the scheduler, the flight crews, the service providers and the authorities.

9. The method of claim 8, wherein a real-time notification is provided to relevant individuals receiving of electronic communications, including the service requests and the confirmations, and wherein said electronic communications are stored in a flight department database with reference to the associated trip.

10. The method of claim 9, further comprising:
obtaining feedback data from one or more passengers, the scheduler, and one or more of the flight crews regarding one or more of the service providers of the trip; and
storing the feedback data into the shared knowledge information database, thereby allowing a scheduler of another trip to obtain the supplemental information.

11. The method of claim 10, wherein the trip parameter is provided by the scheduler via an interactive interface showing a map that allows the scheduler to select the departure location and the destination location, wherein the interactive interface presents the scheduler with a plurality of airports and a selectable list of service providers available at each airport for fulfilling the identified service requirements.

12. The method of claim 11, wherein the service providers include ground handling service provider, fuel service provider, catering service provider, ground transportation provider and lodging service provider, wherein the clearances include overflying permit, landing permit, airworthiness certificate and immigration documents for passengers and flight crews to enter destination country, and wherein the aviation authorities include air traffic control, civil aviation authority, federal aviation administration, customs and immigration agencies.

13. A system for building an on-demand aviation trip, comprising:
one or more user terminals each having a user interface for interacting with one or more users;
one or more databases for storing information regarding a plurality of service providers and information regarding the trip; and
one or more servers for implementing a trip building application that performs one or more tasks, including generation of trip requirement data containing at least one service requirement for the trip, generation of service provider data containing a set of service providers available to fulfill the service requirement, facilitation of selecting a particular service provider from the set for the respective service requirement, and facilitation of communicating a service request and a confirmation request to the selected service provider, wherein said user terminals, servers and databases are linked via a communication network.

14. The system of claim 13, wherein the trip building application is configured to generate the trip requirement data by using a plurality of trip parameters that are provided by the scheduler, wherein said trip parameters comprises at least a departure location, a destination locations, and a schedule for the trip.

15. The system of claim 14, wherein the trip building application is configured to provide a real-time notification for any updates to the trip to the users relevant to said updates, wherein said updates include receipt of messages, receipt of requests and confirmations, and changes in the status of any aspects of the trip that cause the user to perform any manual tasks.

16. The system of claim 15, wherein the service requirement for the trip is identified by the scheduler as a part of the trip parameters, by the flight crews, by the trip building application, or a combination thereof.

17. The system of claim 16, wherein the trip building application is configured to generate the service provider data by sending one or more queries to a service provider database to obtain a set of service providers available to fulfill each service requirement.

18. The system of claim 17, wherein the trip building application is configured to either provide the service provider data to the user terminal of a scheduler for a selection of particular service provider for the identified service requirement or automatically select a service provider by using one or more predetermined criterions defined by the trip building application or pre-defined by the scheduler, or a combination thereof.

19. The system of claim 18, wherein the trip building application further configured to facilitate an online auction among a set of service providers for each of the service requirements identify in the trip requirement data, wherein a request for bid is automatically provided to each service provider determined to be available for fulfilling the respective service requirement, and each bid received from said service provider is either presented on the scheduler for a selection service provider, or used by the trip building application to automatically select a service provider for the service requirement.

20. The system of claim 19, wherein said one or more databases include a shared knowledge database containing information on service level rating, user reviews, certification status and compliance status of the service providers, and wherein the trip building application is configured to integrate the information retrieved from the shared knowledge database into the service provider data to be presented to the scheduler.

21. The system of claim 20, wherein the trip building application configured to identify one or more clearances required for the trip, and wherein the trip building application is further configured to automatically generate a clearance request for each of the required clearances and to provide the generated clearance request to a corresponding aviation authority.

22. The system of claim 21, wherein the trip building application is further configured to obtain feedback data from passengers, the schedulers or the flight crews regarding the service providers of the trip, and store the feedback data into the shared knowledge database, thereby allowing other schedulers to use the stored information in selecting service providers for another aviation trip.

23. The system of claim 22, wherein the trip building application is further configured to periodically retrieve and store all available service request forms and all available clearance request forms from the service providers and the aviation authorities, respectively, wherein the stored forms are used in providing the service request and the clearance request to the service provider and the aviation authority.

24. The system of claim 23, wherein the requests provided to the service providers contain a links for the service providers to register and submit their information or to update their information in the service provider database.

25. The system of claim 24, wherein the service providers include ground handling service provider, fuel service provider, catering service provider, ground transportation provider and lodging service provider, wherein the clearances include overflying permit, landing permit, airworthiness certificate and immigration documents for passengers and flight crews to enter destination country, and wherein the aviation authorities include air traffic control, civil aviation authority, federal aviation administration, customs and immigration agencies.
